(19) United States
(12) Patent Application Publication
(10) Pub. No.: US 2014/0097960 A1
(43) Pub. Date: Apr. 10, 2014

(54) Alarm systems and methods for preventing improper lifting of tubular members

(71) Applicant: Mark GUIDRY, Lafayette, LA (US)

(72) Inventor: Mark GUIDRY, Lafayette, LA (US)

(21) Appl. No.: 13/573,746

(22) Filed: Oct. 4, 2012

(51) Int. Cl. G08B 21/00

(52) U.S. Cl. 340/686.2

(57) ABSTRACT

Systems and methods for preventing improper lifting of tubular members are described, in which sensing devices are used to detect when a tubular reaches a selected position within a lifting device suitable for engagement, and/or to detect when a lifting operation is initiated that would exceed the capacity of a lifting device. Operators are engaged with the tubular member and provided with a preselected force corresponding to the weight of one or more tubular members, such that when the weight of a lifting operation exceeds the preselected force, an audible device can be actuated responsive to sensor output, to immediately alert individuals, such that the improper lifting operation can be halted. Similarly, an audible device can be actuated responsive to sensor output when a tubular member reaches a selected position within the lifting device, such that additional movement can be ceased.

### FIELD

Embodiments within the present disclosure relate, generally, to systems and methods for preventing improper lifting of tubular members through use of alarms responsive to the weight applied during a lifting operation, the position of a tubular member within a lifting device, or combinations thereof.

### BACKGROUND

When assembling a string of tubular members, such as a drill string or casing string, a lifting device, such as an overshot-type casing running tool, normally in conjunction with an elevator or similar gripping apparatus, is engaged with an individual tubular member, then used to move and/or rotate the tubular member to engage the tubular member with an adjacent portion of the tubular string. The lifting device is then disengaged from the tubular string, and the process is repeated. Similarly, when disassembling a string of tubular members, a single member of a tubular string can be engaged by a lifting device, rotated to disengage the tubular member from the string, then lifted and/or otherwise moved.

Conventionally, when engaging a lifting and/or running tool with a tubular member, one or more individuals on a rig floor and/or one or more other visual indicators are used to provide a signal to an operator when the tubular member reaches the correct position within the lifting device for engagement. If an operator continues to move the lifting device after this position has been reached, an improper engagement can result, and/or the lifting device can forcibly contact the tubular member, causing damage to the lifting device and/or the tubular member.

When performing assembly and/or disassembly operations, operators must repetitively perform a sequence of steps that include engaging tubular members with a lifting device, lifting and/or moving the tubular members, torquing the tubular members, disengaging the lifting device, then repeating the process with subsequent tubular members. Due to the repetitive nature of such an undertaking, it is common for an operator to inadvertently skip one or more of these steps, or to lose awareness of the most recent action that was performed. Incomplete torquing of a tubular connection during disassembly can also create difficulty. As a result, it is possible to exceed the maximum lifting capacity of a lifting device by inadvertently attempting to lift multiple connected tubular members at one time. While some systems include visible signals that are provided when an improper lifting operation is undertaken, these signals are often overlooked, especially during situations in which the initial error resulted from operator inattention.

For example, during casing running procedures, a single common load is handled by two operators: a driller responsible for the rig, and the operator of the casing running tool. During casing running operations, the load must be transferred from an elevator or similar lifting apparatus having a limited capacity to the casing running tool. If any miscommunications occur between operators, or if any operations are performed improperly, loads exceeding the capacity of the equipment can be inadvertently applied.

A need therefore exists for systems and methods for preventing improper lifting of tubular members that instantly and effectively alerts operators, and other personnel at a work site, before damage can be incurred through an improper lifting operation.

### BRIEF DESCRIPTION OF THE DRAWINGS

In the detailed description of various embodiments useable within the scope of the present disclosure, presented below, reference is made to the accompanying drawings, in which:

FIG. 1 depicts a perspective view of an embodiment of a system usable within the scope of the present disclosure.

FIG. 2 depicts a detail view of an operator of the system of FIG. 1 in a retracted position.

FIG. 3 depicts a detail view of an operator of the system of FIG. 1 in an extended position.

FIG. 4 depicts a perspective view of an embodiment of a system usable within the scope of the present disclosure prior to engagement of a tubular member.

FIG. 5 depicts the system of FIG. 4 after engagement of the tubular member.

FIG. 6 depicts a diagram of an embodiment of a system usable within the scope of the present disclosure.

One or more embodiments are described below with reference to the listed Figures.

### DETAILED DESCRIPTION OF THE EMBODIMENTS

Before explaining the described embodiments useable within the scope of the present disclosure in detail, it is to be understood that the present invention is not limited to the particular embodiments described herein and that the present invention can be practiced or carried out in various ways.

Embodiments described herein relate to alarm systems and methods for preventing improper lifting of tubular members, and particularly audible alarm systems.

In one embodiment, an audible alarm system can be used in conjunction with a lifting device usable to engage and maneuver a tubular member. For example, a casing running tool, such as the CRT-350, produced by National Oilwell Varco, can be provided for engagement with and assembly or disassembly of one or more segments of casing. While any type of lifting device is usable within the scope of the present disclosure, in an embodiment, the lifting device can include an internal bore for receiving the tubular member, and a slip or similar gripping member for engaging the tubular member once it is received and properly positioned within the internal bore.

A sensing device can be disposed within the internal bore or otherwise secured to the lifting device, for detecting the tubular member when the tubular member achieves a selected position suitable for engagement by the lifting device. For example, the tubular member can contact a mechanical member positioned within the lifting device. Alternately or additionally, a laser device, electronic position sensor, motion detector, or similar device known in the art can be used to determine when the tubular member reaches a selected position relative to the lifting device.

Responsive to detection of the tubular member by the sensing device, an audible device, such as a pneumatic horn and/or an air horn, can be actuated to produce an audible sound, to immediately alert the operator of the lifting device, and/or other personnel at a work site. It should be appreciated that other types of alarm devices are also readily usable with various embodiments of the present invention, such as by way of example, lights. Continued motion of the lifting device can thereby be immediately ceased, preventing improper contact between the lifting device and the tubular member, an improper engagement therebetween, or other potential sources of damage.

Once the lifting device has been engaged with a tubular member, one or more operators, such as for example a cylinder, secured to or otherwise provided in operative association with the lifting device can also be engaged with the tubular member. Thus, when a lifting operation is performed, the weight of the lifting operation is applied to the operator. For example, two fluid and/or gas cylinders, which can include hydraulic or pneumatic cylinders, can be provided on opposing sides of the lifting device, or alternately, a spring or other mechanical biasing member can be used. A collar, single joint elevator, or similar gripping device secured to the one or more operators can be placed around the tubular member. The cylinders or other operators can be provided with a preselected force and/or a known load corresponding to the weight of a single tubular member, the maximum weight capacity of the lifting device, or the maximum weight capacity of an elevator or spider used in conjunction therewith.

When a lifting operation is performed, the weight of the tubular member is first provided to the one or more operators. The preselected force of the one or more operators resists the weight of the lifting operation, such that if the weight of the lifting operation is less than the preselected force, the lifting operation can occur uninterrupted. If the weight of the lifting operation exceeds the preselected force, which can readily occur if multiple connected tubular segments are inadvertently lifted, an audible device, such as an air horn and/or a pneumatic horn, engaged with the operator, can provide an audible alarm to alert the operator of the lifting device and/or other personnel at the work site. The improper lifting operation can thereby be immediately halted before damage is incurred to the tubular members or lifting equipment.

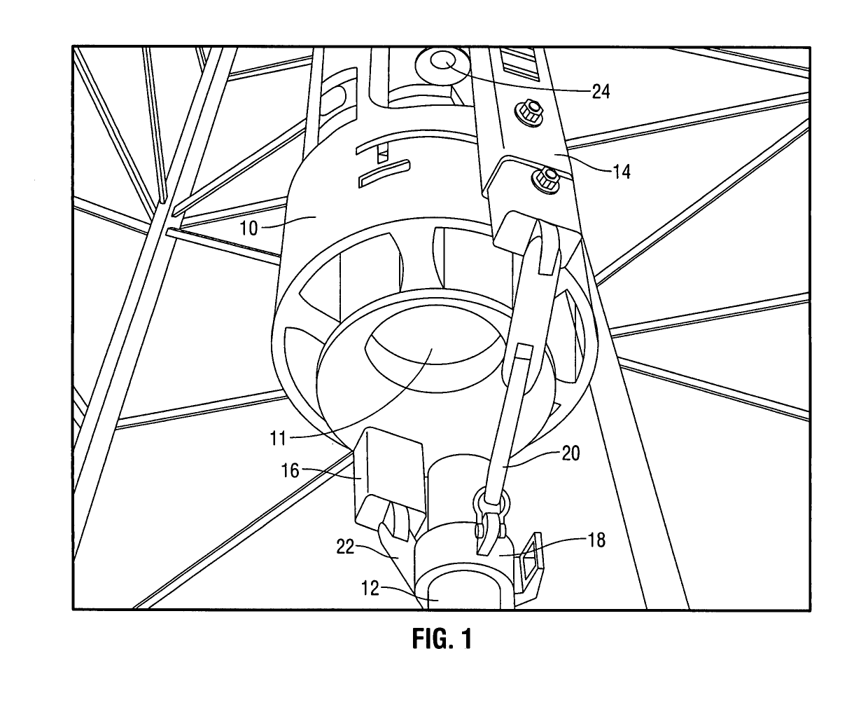

Referring now to FIG. 1, an embodiment of a system usable within the scope of the present disclosure is shown. The depicted system includes a lifting device (10), which is shown as a casing running tool, normally used in conjunction with a single joint elevator or similar gripping device, to handle, torque, and maneuver a tubular member (12). The lifting device (10) includes an internal bore (11) and a gripping device (not visible in FIG. 1). It should be understood that while FIG. 1 depicts a casing running tool, other embodiments of the system can be used with any type of lifting device, adapted to lift or otherwise move any type of tubular member or other object.

A first operator (14) and a second operator (16) are shown secured to opposing sides of the lifting device (10). The first operator (14) is also secured to the tubular member (12) using a first pivotable arm (20), which is engaged with a collar (18) that is disposed about the tubular member (12). Similarly, the second operator (16) is shown secured to the tubular member using a second pivotable arm (22) secured to an opposing side of the collar (18). During typical operations, the collar (18) can include any manner of gripping and/or lifting device, including without limitation a single joint elevator or other type of elevator, a spider, a tong, or other similar devices.

The operators (14, 16) are shown as fluid cylinders, which can include hydraulic, pneumatic, and/or other fluid or gas cylinders, as known in the art, enclosed within a movable housing, which is described in greater detail below. The operators (14, 16) can be adjustable or otherwise able to be provided with a preselected force, or alternatively, the operators can have a known load and/or force, such that when weight is applied to the operators (14, 16) during lifting of the tubular member (12), if the weight exceeds the preselected force or known load of the operators (14, 16), the movable housing will be pulled toward an extended position, and an internal or external sensor (not shown) will be actuated. It should be understood that the sensor within or otherwise associated with the operators (14, 16) can include any manner of contact switch, position detector, electric, hydraulic, pneumatic, or mechanical switch or detector, or combinations thereof, as known in the art. An audible device (24), shown as an air horn, can be provided in operative communication with the sensor, such that responsive thereto, the audible device (24) will produce an audible alarm to attract the immediate attention of the operator and/or other personnel at a work site.

For example, the preselected force and/or known load of the operators (14, 16) can correspond to the weight of a single tubular member, such that if a single tubular member is lifted, the preselected force is not exceeded, and the sensor within or otherwise operatively associated with the operators (14, 16) is not actuated. However, if multiple connected tubular members are inadvertently lifted, the preselected force will be exceeded, causing the sensor to actuate the audible device (24), such that the improper lifting operation can be immediately halted.

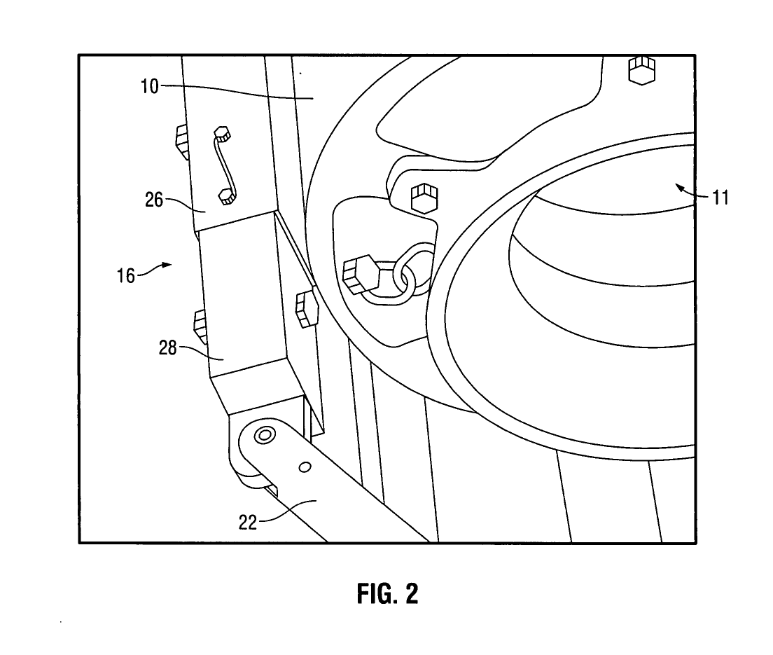

Referring now to FIG. 2, an enlarged view of the second operator (16) is shown, engaged with the lifting device (10), and with the tubular member via the second pivotable arm (22). FIG. 2 depicts the second operator (16) including an upper section (26) and a lower section (28), telescopingly engaged over a central section (not visible in FIG. 2). As weight from the tubular member is applied to the second operator (16) during a lifting operation, the lower section (28) is biased in a downward direction, away from the upper section (26), while the preselected force of the second operator (16) resists this weight. If the weight of the tubular member exceeds the preselected force of the second operator (16), the lower section (28) will be extended away from the upper section (26), and the sensor within the second operator (16) can be actuated.

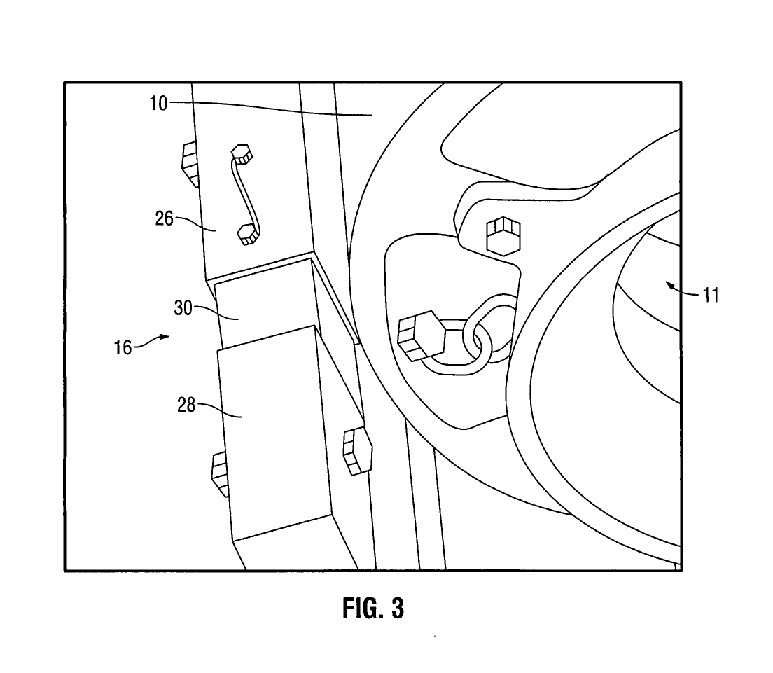

FIG. 3 depicts the lifting device (10) in association with the second operator (16) in an extended position, the weight associated with a lifting operation having pulled the lower section (28) apart from the upper section (26) such that the central section (30) is visible.

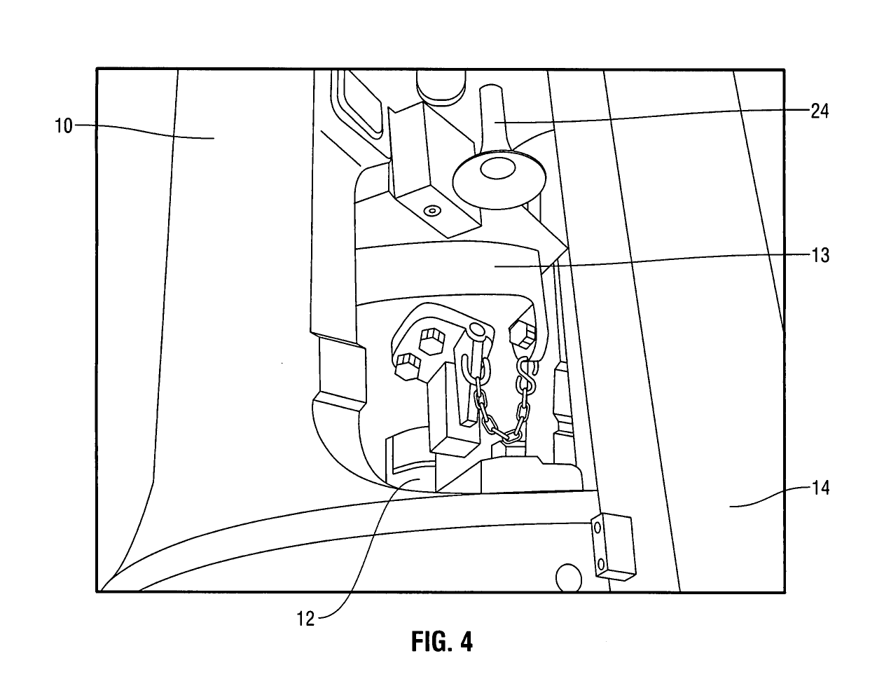

Referring now to FIG. 4, an embodiment of a system usable within the scope of the present disclosure is shown, prior to engagement between a lifting device (10) and a tubular member (12). As the tubular member (12) is inserted within the internal bore of the depicted lifting device (10), a gripping member (13), which can include any manner of slips, rings, collars, seals, or other gripping and/or lifting devices as known in the art, is usable to engage the tubular member (12). In an embodiment, the gripping member (13) can be configured to automatically engage the tubular member (12) once the tubular member (12) has reached a selected position within the interior of the lifting device (10).

However, due to the possibility that a user may inadvertently maneuver the lifting device (10) and/or the tubular member (12) after the tubular member (12) reaches a position suitable for engagement, potentially causing an impact between the lifting device (10) and the tubular member (12), and/or allowing for an improper engagement, the system can also include a sensing device (not visible in FIG. 4) for detecting the position of the tubular member (12). For example, a mechanical member adapted to contact the tubular member (12) when the tubular member (12) reaches a position suitable for engagement by the lifting device (10) can be provided. Other sensing devices, such as electrical devices, laser devices, motion sensors, and similar devices known in the art are also usable. Responsive to detection by the sensing device, a horn or similar audible device, which can include the audible device (24) or a second audible device, can produce an audible sound to alert an operator and/or other individuals at a work site.

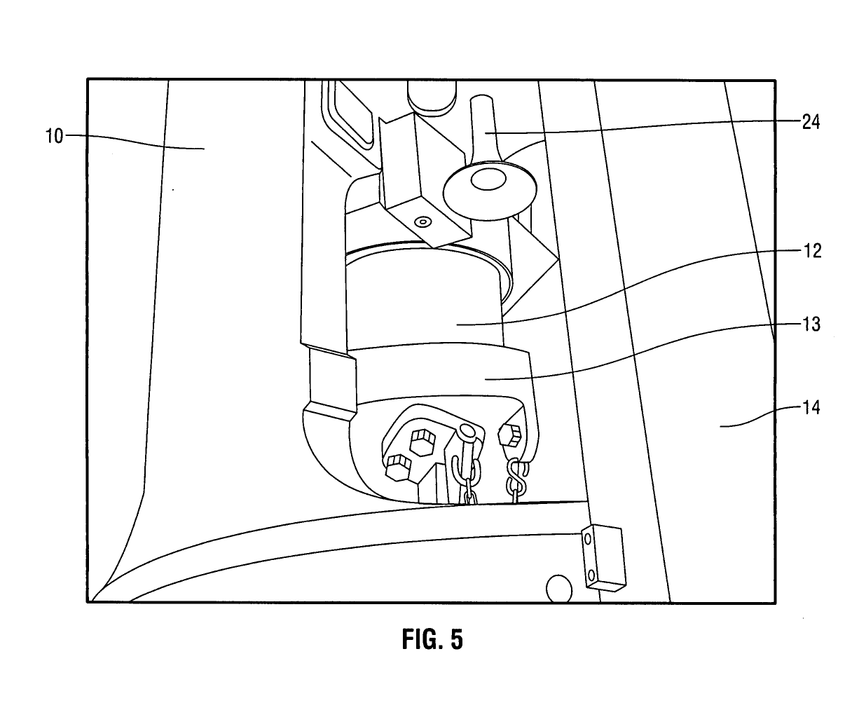

FIG. 5 depicts the lifting device (10) of FIG. 4 after the gripping member (13) has been moved to engage the tubular member (12). As described previously, movement of the gripping member (13) can occur automatically after the tubular member (12) reaches a selected position within the lifting device (10), while additional movement after the tubular member (12) has reached this position can be prevented through actuation of an audible device (24). An operator (14), as described previously, is also shown engaged to the lifting device (10).

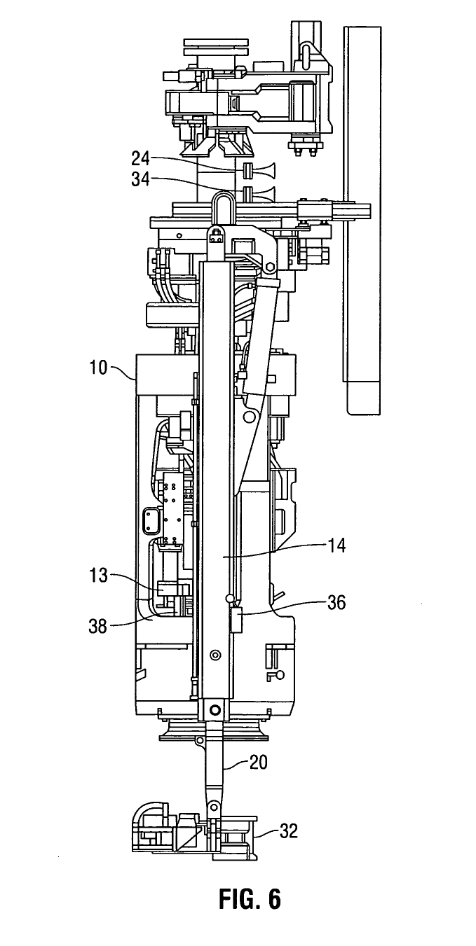

Referring now to FIG. 6, a diagram of an embodiment of a system usable within the scope of the present disclosure is shown. Specifically, a lifting device (10) configured to engage tubular members using a gripping member (13), as described previously, is shown. Within an internal bore of the lifting device (10), proximate to the gripping member (13), a sensing device (38) is shown, which can determine a position of a tubular member within the lifting device (10) when contacted by the tubular member. Responsive to output from the sensing device (38), a pneumatic horn (34) or similar audible device can be actuated, such that an operator can immediately halt movement of the lifting device (10) and/or the tubular member when the tubular member occupies a position suitable for engagement.

An operator (14) is also shown engaged to the lifting device (10), as described previously, the operator (14) being operatively connected to a single joint elevator (32) or similar lifting device by a pivotable arm (20). A sensing device (36) is disposed on the operator (14) for determining when a weight applied to the operator (14) during lifting of a tubular member engaged by the lifting device (10) and/or the single joint elevator (32) exceeds a preset force or known weight of the operator (14). Responsive to output from the sensing device (36), an audible device (24) can provide an audible alarm when the preselected force of the operator (14) is exceeded, as described previously, such that an operator can immediately halt an improper lifting operation that could potentially damage the tubular member, lifting device (10), single joint elevator (32) or other equipment.

Each of the depicted audible devices (24, 34) can include separate pneumatic and/or air supplies, and can produce sounds that are readily able to be differentiated, such that operators and/or other individuals at a work site can remain contemporaneously aware when a tubular member reaches a selected position within the lifting device (10) and/or when a lifting operation that exceeds the preselected force of the operator (14) is initiated.

While various embodiments useable within the scope of the present disclosure have been described with emphasis, it should be understood that within the scope of the appended claims, the present invention can be practiced other than as specifically described herein.

What is claimed is:

1. An audible alarm system for preventing improper alignment of tubular members, the system comprising:
a lifting device adapted to engage and lift a tubular member;
a sensing device secured to the lifting device and adapted to detect a selected position of the tubular member relative to the lifting device; and
an audible device operatively engaged with the sensing device, wherein the audible device produces an audible sound when the sensing device detects the selected position of the tubular member for preventing improper alignment between the lifting device and the tubular member.

2. The audible alarm system of claim 1, wherein the lifting device comprises a tubular running tool having an internal bore for receiving the tubular member and a gripping member for engaging the tubular member when the tubular member is received in the internal bore, and wherein the sensing device detects the selected position of the tubular member within the internal bore.

3. The audible alarm system of claim 2, wherein the sensing device comprises a mechanical member disposed within the internal bore and adapted to contact the tubular member.

4. The audible alarm system of claim 1, wherein the audible device comprises a horn.

5. The audible alarm system of claim 1, further comprising:
an operator secured to the lifting device and the tubular member, wherein a weight of a lifting operation is applied to the operator when the lifting device engages and lifts the tubular member, and wherein the operator is provided with a preselected force corresponding to a weight associated with the tubular member, a maximum weight of the lifting device, or combinations thereof; and
an additional audible device operatively engaged with the operator, wherein the additional audible device produces an audible alarm when the weight of the lifting operation exceeds the preselected force for preventing improper lifting of the tubular member.

6. The audible alarm system of claim 5, wherein the operator comprises a hydraulic cylinder, a pneumatic cylinder, a mechanical biasing member, or combinations thereof.

7. An audible alarm system for preventing damage due to improper alignment, engagement, or lifting of tubular members, the system comprising:
a lifting device adapted to engage and lift a tubular member;
an operator secured to the lifting device and the tubular member, wherein a weight of a lifting operation is applied to the operator when the lifting device engages and pulls the tubular member, and wherein the operator is provided with a preselected force corresponding to a weight associated with the tubular member, a maximum weight of the lifting device, or combinations thereof;
a sensing device secured to the lifting device and adapted to detect a selected position of the tubular member relative to the lifting device;
a first audible device operatively engaged with the operator, wherein the first audible device produces a first audible alarm when the weight of the lifting operation exceeds the preselected force for preventing improper lifting of the tubular member; and
a second audible device operatively engaged with the sensing device, wherein the second audible device produces a second audible sound when the sensing device detects the selected position of the tubular member for preventing improper alignment between the lifting device and the tubular member.

8. The audible alarm system of claim 7, wherein the lifting device comprises a tubular running tool having an internal bore for receiving the tubular member and a gripping member for engaging the tubular member when the tubular member is received in the internal bore, and wherein the sensing device detects the selected position of the tubular member within the internal bore.

9. The audible alarm system of claim 8, wherein the sensing device comprises a mechanical member disposed within the internal bore and adapted to contact the tubular member.

10. The audible alarm system of claim 7, wherein the operator comprises a hydraulic cylinder, a pneumatic cylinder, a mechanical biasing member, or combinations thereof.

11. A method for preventing improper alignment of tubular members, the method comprising the steps of:
initiating an operation to engage a tubular member with a lifting device;
detecting a selected position of the tubular member relative to the lifting device; and
providing an audible sound when the tubular member occupies the selected position, thereby preventing improper alignment between the lifting device and the tubular member.

12. The method of claim 11, wherein the step of initiating the operation to engage the tubular member with the lifting device comprises receiving the tubular member within an internal bore of the lifting device and engaging a gripping member of the lifting device with the tubular member.

13. The method of claim 12, wherein the step of detecting the selected position of the tubular member comprises contacting the tubular member with a mechanical member disposed within the internal bore.

14. The method of claim 11, wherein the step of providing the audible sound comprises actuating a horn.

15. The method of claim 11, further comprising the steps of:
providing an operator with a preset force corresponding to a weight associated with a tubular member;
engaging the operator and the lifting device with the tubular member;
initiating a lifting operation with the lifting device, wherein a weight of the lifting operation is applied to the operator; and
providing an audible alarm if the weight of the lifting operation exceeds the preselected force, thereby preventing improper lifting of the tubular member.

16. The method of claim 15, wherein the step of providing the audible alarm comprises actuating a horn.

17. The method of claim 15, wherein the step of initiating the lifting operation further comprises receiving the weight of the lifting operation by a hydraulic cylinder, a pneumatic cylinder, a mechanical biasing member, or combinations thereof, and applying the preselected force in a direction opposite the direction of the weight of the lifting operation using the hydraulic cylinder, the pneumatic cylinder, the mechanical biasing member, or combinations thereof.

18. A method for preventing damage due to improper lifting, engagement, or alignment of tubular members, the method comprising the steps of:
providing an operator with a preset force corresponding to a weight associated with a tubular member;
initiating an operation to engage the tubular member with a lifting device;
detecting a selected position of the tubular member relative to the lifting device;
providing an audible sound when the tubular member occupies the selected position, thereby preventing improper alignment between the lifting device and the tubular member;
engaging the operator and the lifting device with the tubular member;
initiating a lifting operation with the lifting device, wherein a weight associated with the lifting operation is applied to the operator; and
providing an audible alarm if the weight associated with the lifting operation exceeds the preselected force, thereby preventing improper lifting of the tubular member.

19. The method of claim 20, wherein the step of initiating the operation to engage the tubular member with the lifting device comprises receiving the tubular member within an internal bore, and wherein the step of engaging the tubular member with the lifting device comprises engaging a gripping member of the lifting device with the tubular member.

20. The method of claim 20, wherein the step of detecting the selected position of the tubular member comprises contacting the tubular member with a mechanical member disposed within the internal bore.
